(19) United States
(12) Patent Application Publication
(10) Pub. No.: US 2016/0227100 A1
(43) Pub. Date: Aug. 4, 2016

(54) DUAL CAMERA SYSTEMS AND METHODS FOR RAPID 3A CONVERGENCE AND HIGH DYNAMIC RANGE EXPOSURE METERING

(71) Applicant: QUALCOMM Incorporated, San Diego, CA (US)

(72) Inventors: Shizhong Liu, San Diego, CA (US); Hung-Hsin Wu, San Diego, CA (US); Venkata Ravi Kiran Dayana, San Diego, CA (US); Narayana Karthik Sadanandam Ravirala, San Diego, CA (US); Yonggui Mao, San Diego, CA (US); Karthikeyan Shanmugavadivelu, San Diego, CA (US)

(21) Appl. No.: 14/609,264

(22) Filed: Jan. 29, 2015

(51) Int. Cl. H04N 5/232; H04N 5/235

(52) U.S. Cl. CPC H04N 5/23212; H04N 5/23216; H04N 5/23248; H04N 5/2353

(57) ABSTRACT

Systems and methods for rapid automatic focus, automatic white balance, and automatic exposure control are disclosed. To reduce the time it takes to automatically focus, balance spectra, and set exposure period, a dual camera uses an auxiliary camera and auxiliary image processing module in addition to the main camera and main image processing module. The auxiliary camera may capture lower resolution and lower frame rate imagery that is processed by an auxiliary image processing module to determine focus, white balance, and exposure periods for the main camera and main image processing module. By initiating convergence for automatic focus (AF), automatic white balance (AWB) and automatic exposure control (AEC) before receiving a command to capture imagery, and processing lower resolution and lower frame rate imagery, AF, AWB, and AEC convergence delays are reduced for both standard and high dynamic range image capture.

### FIELD

This application relates generally to imaging systems, and more specifically to multiple camera systems and methods for controlling same.

### BACKGROUND

To take pictures or video that are in focus, spectrally balanced, and exposed properly, cameras may include functions including automatic focus (AF), automatic white balance (AWB), and automatic exposure control (AEC). These three functions (sometimes referred to herein as “3A”) enable an imaging system to produce focused, balanced, and properly exposed still or video images. When a camera is first turned on or actuated from a non-imaging state it may take some time for a camera to determine where to position one or more lenses to properly focus an image on an image sensor, determine white balance and/or exposure information. When the camera is turned on, or when ambient lighting conditions change, determining parameters that a camera needs to properly focus, determine optimum exposure (for example, an exposure time period and an aperture size used for the exposure), and to perform white balance of captured images may be too long, resulting in a delay before the camera allows an image to be captured. This delay is perceptible and is commonly seen in digital photography.

Scenes with high dynamic range include dark and light regions requiring long and short exposure periods, respectively, so that detail is visible. High dynamic range imagery may be taken by combining images taken with different exposure periods. Therefore, there is a need for different exposure periods for a single scene with high dynamic range so that detail in both dark and light regions is visible. When the camera is turned on, or when ambient lighting conditions change, the 3A convergence time as well as the time to converge to the exposures required to capture and combine high dynamic range imagery may be too long, resulting in a delay before being able to take focused, balanced, and well exposed high dynamic range imagery. Therefore, there is a need to reduce the 3A and high dynamic range exposure convergence times for cameras.

### SUMMARY

A summary of sample aspects of the disclosure follows. For convenience, one or more aspects of the disclosure may be referred to herein simply as “some aspects.”

Methods and apparatuses or devices being disclosed herein each have several aspects, no single one of which is solely responsible for its desirable attributes. Without limiting the scope of this disclosure, for example, as expressed by the claims which follow, its more prominent features will now be discussed briefly. After considering this discussion, and particularly after reading the section entitled “Detailed Description” one will understand how the features being described provide advantages that include allowing for multicasting using Bluetooth wireless technologies.

One innovation is an apparatus. The apparatus includes a main camera including a main sensor. The main camera is configured to receive main image capture information, and capture an image using the main sensor and the image capture information. The apparatus also includes a main image processing module in communication with the main camera. The main image processing module is configured to receive an image from the main camera, receive main image processing information, and process the image received from the main camera using the main image processing information. The apparatus also includes an auxiliary camera including an auxiliary sensor. The auxiliary camera is configured to capture an image using the auxiliary sensor. The apparatus also includes an auxiliary image processing module in communication with the auxiliary camera. The auxiliary image processing module is configured to receive at least one image from the auxiliary camera and determine auxiliary control information based on the at least one image received from the auxiliary camera. The apparatus also includes a camera controller in communication with the auxiliary image processing module. The camera controller is configured to receive the auxiliary control information from the auxiliary image processing module. The cameral controller is further configured to determine main image capture information and main image processing information from the auxiliary control information. The cameral controller is further configured to communicate the main image capture information to the main camera, and communicate main image processing information to the main image processing module.

For some implementations, the auxiliary control information includes information for controlling the auxiliary camera and processing the auxiliary image. For some implementations, the main image capture information includes information for operating the main camera to perform autofocus operations. For some implementations, the auxiliary control information comprises exposure information. For some implementations, the main image capture information includes information for controlling an exposure of the main sensor while capturing an image. For some implementations, the main image processing information comprises information for performing a white balance adjustment of an image received from the main camera.

For some implementations, the main image processing module is further configured to determine main control information. For some implementations, the camera controller receives main control information from the main image processing module. For some implementations, the camera controller determines additional main image capture information based at least in part on the auxiliary control information and the received main control information. For some implementations, the camera controller communicates the additional main image capture information for autofocus and exposure control to the main camera.

For some implementations, the main camera is configured to receive the main image capture information from the camera controller and perform autofocus operations based on the received main image capture information.

For some implementations, the auxiliary control information includes autofocus data. For some implementations, the auxiliary camera comprises an auxiliary lens. For some implementations, the auxiliary image processing module and the auxiliary camera are collectively configured to determine the autofocus data by moving the auxiliary lens to a plurality of positions, capturing an image at each of the positions, and determining at which position an image includes the most high frequency information.

For some implementations, auxiliary control information comprises white balance information. For some implementations, the auxiliary image processing module is configured to determine the white balance by comparing intensity values for a plurality of spectral regions of an image captured by the auxiliary sensor.

For some implementations, the camera controller is configured to switch to an auxiliary capture mode in response to powering on the apparatus, or when the apparatus operates switches from a recording mode to a non-recording mode. For some implementations, the camera controller is configured to determine the main image capture information and the main image processing information while in the auxiliary image capture mode based on the at least one image received from the auxiliary camera.

Another innovation is a method. In various embodiments the method may include capturing at least one auxiliary image by an auxiliary camera. The method may further include determining, by an auxiliary image processing module, auxiliary control information based on the at least one auxiliary image. The method may further include determining, by a camera controller, main image capture information and main image processing information from the auxiliary control information. The method may include capturing at least one main image by a main camera using the main image capture information. The method may further include receiving the at least on main image and main image processing information at a main image processing module. The method may further include processing, by the main image processing module, the at least one main image using the main image processing information.

For some implementations, the auxiliary control information includes autofocus information, exposure information and white balance information for controlling the auxiliary camera and processing the at least one auxiliary image. For some implementations, the main image capture information includes autofocus information and exposure information for use by the main camera. For some implementations, the main image processing information includes white balancing information for use by the main image processing module. For some implementations, the method further includes switching to an auxiliary capture mode when the apparatus is powered on. For some implementations, the method further includes switching to an auxiliary capture mode when the apparatus switches from a recording mode to a non-recording mode. For some implementations, the at least one auxiliary image is captured when the apparatus is in the auxiliary capture mode.

For some implementations, the method further includes determining additional main control information based on the at least one main image. For some implementations, the method further includes communicating the additional main control information to the camera controller. For some implementations, the method further includes determining additional main image capture information by the camera controller, the additional main image capture information based at least in part on the auxiliary control information and the additional main control information.

For some implementations, the method further includes communicating the additional main image capture information to the main camera. For some implementations, the method further includes using the additional main image capture information by the main camera to perform autofocus and control exposure while capturing at least one additional main image. For some implementations, the additional main control information is determined by the main image processing module.

Another innovation is an apparatus. In some embodiments, the apparatus may include means for means for capturing at least one auxiliary image. In some embodiments, the apparatus may include means for determining auxiliary control information based on the at least one auxiliary image. In some embodiments, the apparatus may include means for determining main image capture information and main image processing information from the auxiliary control information. In some embodiments, the apparatus may include means for capturing at least one main image using the main image capture information. In some embodiments, the apparatus may include means for receiving the at least one main image and main image processing information at a means for processing the at least one main image. In some embodiments, the apparatus may include means for processing the at least one main image using the main image processing information.

In some embodiments, the auxiliary control information includes autofocus information, exposure information and white balance information for controlling the means for capturing at least one auxiliary image and processing the at least one auxiliary image. In some embodiments, the main image capture information comprises autofocus information and exposure information for use by the means for capturing at least one main image. In some embodiments, the main image processing information comprises white balancing information for use by the means for capturing at least one main image.

In some embodiments, the apparatus may include means for switching to an auxiliary capture mode when the apparatus is powered on. In some embodiments, the apparatus may include means for switching to an auxiliary capture mode when the apparatus switches from a recording mode to a non-recording mode. In some embodiments, the at least one auxiliary image may be captured when the apparatus is in the auxiliary capture mode.

In some embodiments, the apparatus may include means for determining additional main control information based on the at least one main image. In some embodiments, the apparatus may include means for determining additional main image capture information by the camera controller, the additional main image capture information based at least in part on the auxiliary control information and the additional main control information.

In some embodiments, the apparatus may include means for communicating the additional main image capture information to the means for capturing at least one main image. In some embodiments, the means for capturing at least one main image is configured to use the additional main image capture information by to perform autofocus and control exposure while capturing at least one additional main image.

Another innovation is a computer program product comprising a non-transitory computer readable medium encoded thereon with instructions that when executed cause an apparatus to perform a method of capturing an image. The method may include capturing at least one auxiliary image by an auxiliary camera. The method may further include determining auxiliary control information based on the at least one auxiliary image. The method may further include determining main image capture information and main image processing information from the auxiliary control information. The method may include capturing at least one main image by a main camera using the main image capture information. The method may further include receiving the at least on main image and main image processing information at a main image processing module. The method may further include processing the at least one main image using the main image processing information.

For some embodiments, the auxiliary control information includes autofocus information, exposure information and white balance information for controlling the auxiliary camera and processing the at least one auxiliary image. For some embodiments, the main image capture information includes autofocus information and exposure information for use by the main camera. For some embodiments, the main image processing information comprises white balancing information for use by the main image processing module.

Another innovation is an apparatus that includes a main camera having a main sensor. In some embodiments, the main camera is configured to receive control information to perform autofocus operations and control exposure of the main sensor. The apparatus may further includes a main image processing module, coupled to the main camera, configured to receive main control information to perform white balance adjustment of an image received from the main camera, an auxiliary camera having an auxiliary sensor, an auxiliary image processing module, coupled to the auxiliary camera, configured to determine auxiliary control information for performing autofocus operations and control exposure of the auxiliary sensor based on at least one image received from the auxiliary camera. The apparatus may include a camera controller coupled to the auxiliary image processing module. The camera controller may be configured to receive the auxiliary control information from the auxiliary image processing module. The camera controller may be configured to determine, using a processor, main control information from the auxiliary control information, and configured to communicate main control information for autofocus and exposure control to the main camera. The camera controller may be configured to communicate main control information for white balance to the main image processing module.

For some implementations, the main image processing module is further configured to determine main control information. For some implementations, the camera controller receives main control information from the main image processing module. For some implementations, the camera controller determines additional main control information based in part on the auxiliary control information and the received main control information. For some implementations, the camera controller communicates the additional main control information for autofocus and exposure control to the main camera. The camera controller may communicate the additional camera control information for white balance to the main imaging processing module. For some implementations, the main camera is configured to receive the main control information for autofocus operations from the camera controller and perform autofocus operations using the received main control information. For some implementations, auxiliary control information includes autofocus data. For some implementations, the auxiliary camera comprises an auxiliary lens. For some implementations, the auxiliary image processing module is further configured to determine the autofocus data by moving the auxiliary lens to a plurality of positions, capturing an image at each of the positions, and determine at which position an image includes the most high frequency information. For some implementations, determining the first main exposure period comprises analyzing an intensity histogram. For some implementations, determining white balancing for the primary image processing module comprises comparing intensity values for a plurality of spectral regions. For some implementations, the processor is configured to switch to an auxiliary capture mode in response to powering on the dual camera, or in response to a user command to stop capturing video. For some implementations, the processor is configured to determine the main focus distance, the first main exposure period, and the white balance for the main image processing module while in the auxiliary capture mode based on the at least one image received from the auxiliary camera. For some implementations, the processor is configured to switch to a main capture mode in response to a user command to capture video. For some implementations the processor is configured to determine the main focus distance, the first main exposure period, and the white balance for the main image processing module while in the main capture mode based on the at least one image received from the auxiliary camera. For some implementations, the processor maybe further configured to determine a second main exposure period and a third main exposure period of the main image processing module. For some implementations, the second and the third exposure periods are based on the at least one image received from the auxiliary camera, the second main exposure period shorter than the first main exposure period, the third main exposure period longer than the second main exposure period. The second and third exposure periods may be based on the at least one image received from the auxiliary camera and the at least one image received from the main camera, the second exposure period shorter than the first main exposure period, the third main exposure period longer than the first exposure period. For some implementations, the main image processing module is further configured to generate a composite image by combining images captured by the main image processing module at the first main exposure period, the second main exposure period, and third main exposure periods.

Another innovation is a method for automatic exposure control, automatic white balance, and automatic focus for a dual camera. In various embodiments the method may include capturing, by an auxiliary image processing module, a first plurality of images focused on a first image sensor at a first resolution at a first frame rate. The method may further include measuring a first plurality of image statistics in response to the first plurality of images, and determining a main focus distance between a main lens and a main image processing module based on the first plurality of image statistics. The method may further include determining a first exposure period of the main image processing module based on the first plurality of image statistics, and determining white balancing for the main image processing module based on the first plurality of image statistics. The method may further includes capturing, by the main image processing module, a second plurality of images focused on a second image sensor at a second resolution at a second frame rate, the second resolution higher than the first resolution, the second frame rate higher than the first frame rate.

### BRIEF DESCRIPTION OF THE DRAWINGS

FIG. 1 illustrates an example of an apparatus (for example, a mobile communication device) that includes an imaging system having two cameras that can record images of a scene.

FIG. 2A is a block diagram illustrating certain functionality of several components in an embodiment of an imaging system having two cameras, including an example of control information determined from images generated by a first camera (for example, an auxiliary camera) and then used to determine control information for a second camera (for example, a main camera).

FIG. 2B is a block diagram representation of an example of an embodiment of an imaging system that has two cameras and can be incorporated into an apparatus, for example, a camera, computer or mobile device.

FIG. 2C is a block diagram representation of an example of an embodiment of an imaging system, with high dynamic range exposure metering, that has two cameras and can be incorporated into an apparatus, for example, a camera, computer or mobile device.

FIG. 3A is a representation of an image that illustrates an example of a high dynamic ranges scene captured at an “optimal” exposure.

FIG. 3B is a representation of an image that illustrates an example of the same scene illustrated in FIG. 3A where the image was made using about half the exposure period as was used to capture the image in FIG. 3A.

FIG. 3C is a representation of an image that illustrates an example of the same scene illustrated in FIG. 3A where the image was made using about twice the exposure period as was used to capture the image in FIG. 3A.

FIG. 3D is a representation of an image that illustrates an example of a high dynamic range image generated by combining the images illustrated in FIGS. 3A, 3B and 3C.

FIG. 4 is a state diagram illustrating an example of states and state transitions for some embodiments of an embodiment of an imaging system having two cameras, the state diagram showing states of a main camera and an auxiliary camera during autofocus, automatic white balance and automatic exposure control operations, and as the imaging system captures focused, balanced, and properly exposed imagery.

FIG. 5 is a flowchart that illustrates an example of a method for rapid automatic exposure control, automatic white balance, and automatic focus convergence.

FIG. 6 is a block diagram illustrating an example of an imaging system having two cameras (for example, each camera having a lens and a sensor) configured for automatic exposure control, automatic white balance, automatic focus, and high dynamic range exposure metering.

### DETAILED DESCRIPTION OF CERTAIN EMBODIMENTS

The following detailed description is directed to certain specific embodiments of the invention. However, the invention can be embodied in a multitude of different ways. It should be apparent that the aspects herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

Further, the systems and methods described herein may be implemented on a variety of different computing devices that hosts a camera. These include mobile phones, tablets, dedicated cameras, wearable computers, personal computers, photo booths or kiosks, personal digital assistants, ultra-mobile personal computers, and mobile internet devices. They may use general purpose or special purpose computing system environments or configurations. Examples of computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

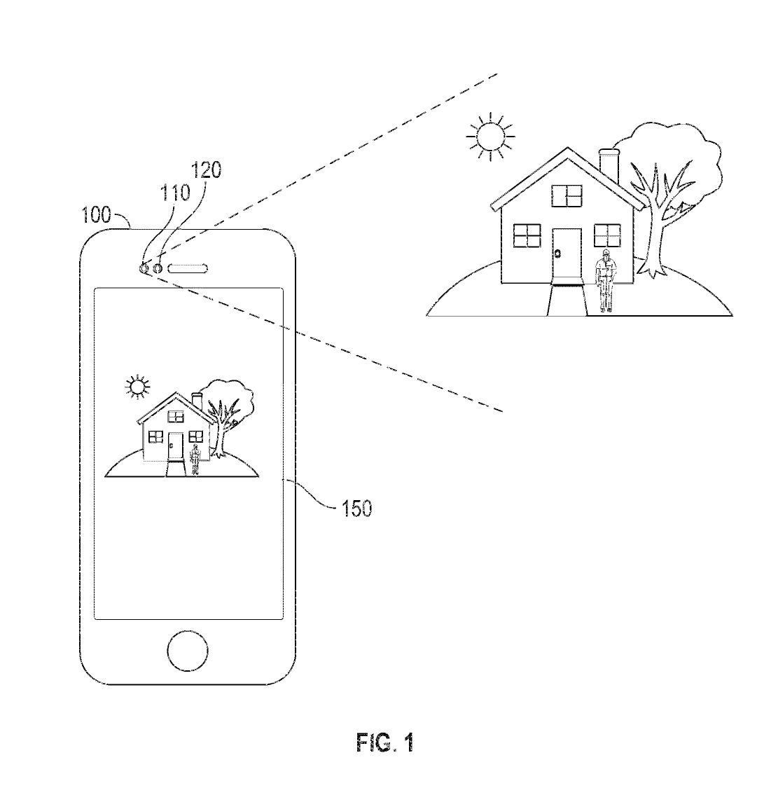

FIG. 1 illustrates an example of an apparatus (for example, a mobile communication device) that includes an imaging system having two cameras that can record images of a scene. In the example embodiment of FIG. 1, an apparatus 100 is illustrated as a mobile communication device (for example, cell phone). Embodiments of the apparatus 100 may include, but are not limited to, a tablet computer, a dedicated camera, wearable computer, a laptop computer, an electronic communication device, or other suitable electronic device that can incorporate an imaging system having at least two cameras. The two (or dual) camera embodiment of FIG. 1 includes a main camera 110 and an auxiliary camera 120 that can capture single images or a plurality of images in a series (for example, video) of an object(s) or a scene. In some implementations, three or more cameras may be used and incorporate the systems and processes described herein for controlling at least one of the cameras. In this illustrative embodiment, the main camera 110 and the and auxiliary camera 120 may include functions including automatic focus (autofocus or AF), automatic white balance (AWB), and automatic exposure control (AEC) to produce pictures or video that are in focus, spectrally balanced, and at exposed properly. AWB, AEC and AF are sometimes referred to herein as 3A functions, and the control data used in AWB, AEC and AF operations may be referred to as 3A control data.

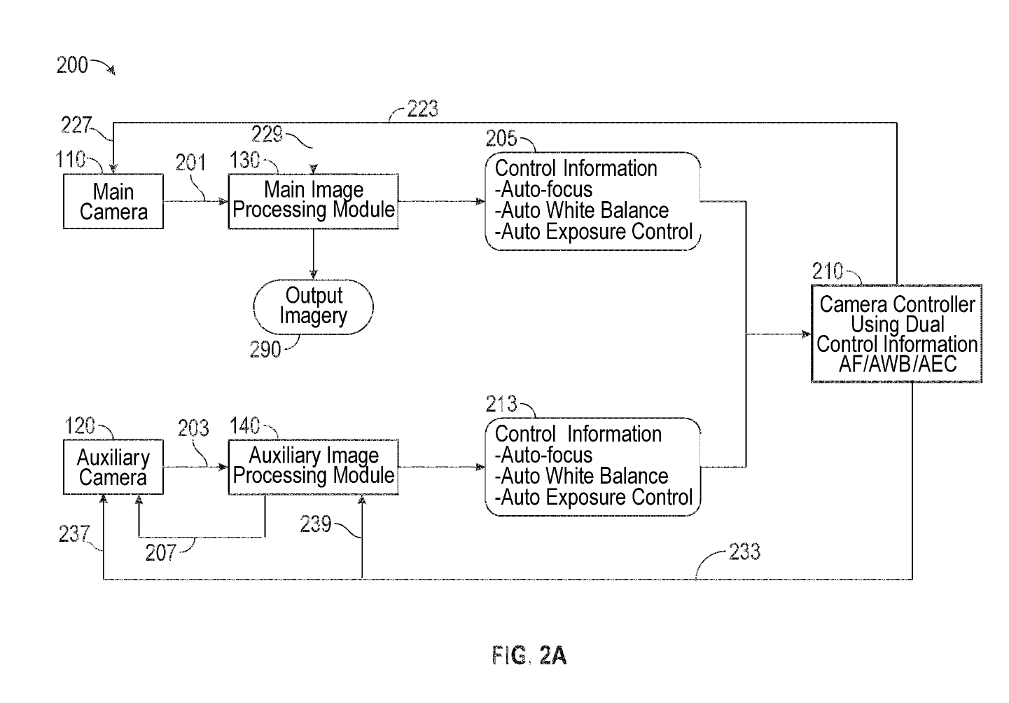

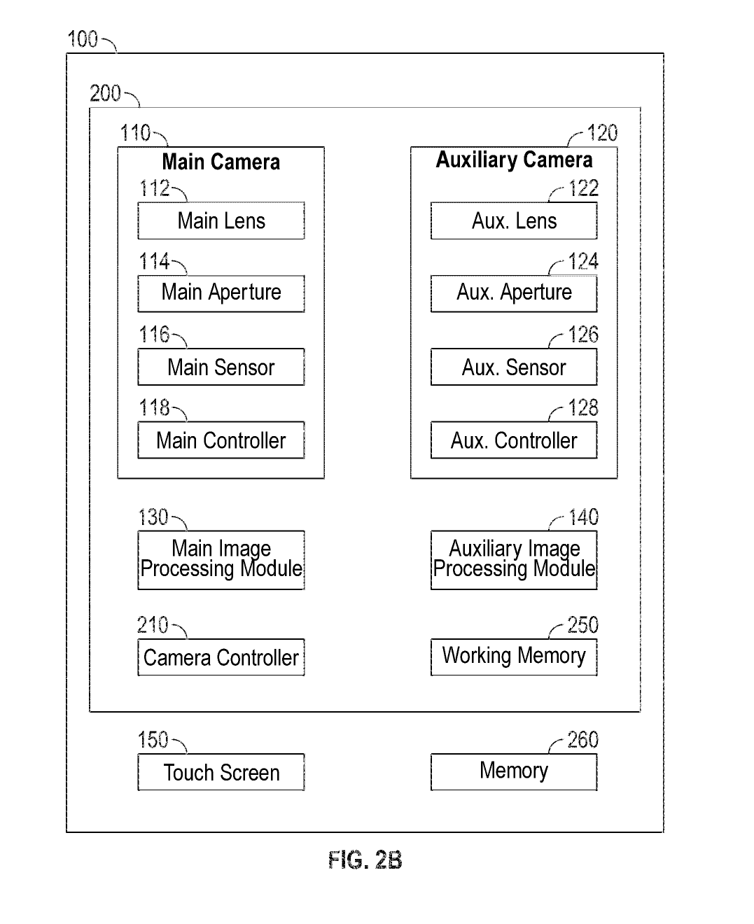

FIG. 2A is a block diagram illustrating certain functionality of several components in an embodiment of an imaging system 200 that may be incorporated in an apparatus (for example, the apparatus 100 illustrated in FIG. 1). FIG. 2B is a block diagram representation of an example of an embodiment of an imaging system that has two cameras and can be incorporated into an apparatus, for example, a camera, computer or mobile device. In the embodiment illustrated in FIG. 2A, the imaging system 200 includes two cameras, including an example of control information determined from images generated by a first camera (for example, an auxiliary camera) and then used to determine control information for a second camera (for example, a main camera). Certain components of the imaging system are further shown in FIG. 2B.

FIG. 2C is a block diagram representation of an example of an embodiment of an imaging system, with high dynamic range exposure metering, that has two cameras and can be incorporated into an apparatus, for example, a camera, computer or mobile device. In particular, FIG. 2C is a block diagram illustrating certain functionality of several components in an embodiment of an imaging system 200 that may be incorporated in an apparatus (for example, the apparatus 100 illustrated in FIG. 1). The functionality of the embodiment of FIG. 2C includes exposure control for, and capture of, high dynamic range (HDR) images.

Referring to FIGS. 2A, 2B, and 2C, embodiments of the imaging system 200 may include a main camera 110 coupled to a main image processing module 130 and can communicate image data (video or “still” images) 201 from the main camera 110 to the main image processing module 130. In various embodiments, the main camera 110 may be coupled to the main image processing module 130 by one or more wired or wireless connections. The coupling of the main camera 110 to the main image processing module 130 includes embodiments where data (for example, images and/or image capture information) is received from main camera 110 and stored, and then communicated to the main image processing module 130. The apparatus also includes an auxiliary camera 120 coupled to an auxiliary image processing module 140 to communicate image data (video or “still” images) 203 from the auxiliary camera 110 to the auxiliary image processing module 140. In various embodiments, the auxiliary camera 120 may be coupled to the auxiliary image processing module 140 by one or more wired or wireless connections. A coupling of the auxiliary camera 120 to the main auxiliary processing module 140 also includes embodiments where data (for example, images and/or image capture information) is received from auxiliary camera 120 and stored, and then communicated to the auxiliary image processing module 140.

FIG. 2B illustrates the main camera 110 and a main image processing module 130, and an auxiliary camera 120 and an auxiliary image processing module 140. Components of the imaging system 200 and certain aspects of their functionality are described below with reference to both FIGS. 2A and 2B.

Referring to FIG. 2A, the main image processing module 130 can determine (for example, it may generate) control information 205 from the data it receives from the main camera 110. In some embodiments, the control information 205 may be used by the main image processing module 130 to control autofocus, auto white balance, and/or automatic exposure operations for the main camera 110, as illustrated by representative feedback connection 227. The main image processing module 130 can also provide control information 205 as an output to be used for further processing. The auxiliary image processing module 140 may determine (for example it may generate) control information 213 from the data it receives from the auxiliary camera 120. In some embodiments, the control information 213 may be used by the auxiliary image processing module 140 to control autofocus, auto white balance, and/or automatic exposure operations for the auxiliary camera 120, as illustrated by representative feedback connection 207. The auxiliary image processing module 140 can also provide control information 213 as an output to be used for further processing.

Referring to FIG. 2C, the main image processing module 130 can determine (that is, it may generate) control information 305 from the data it receives from the main camera 110. In some embodiments, the control information 305 may be used by the main image processing module 130 to control autofocus, auto white balance, and/or automatic exposure operations for the main camera 110, as well as short and long exposure periods to capture high dynamic range images, as illustrated by representative feedback connection 327. The main image processing module 130 can also provide control information 305 as an output to be used for further processing. The auxiliary image processing module 140 may determine (that is, it may generate) control information 313 from the data it receives from the auxiliary camera 120. In some embodiments, the control information 313 may be used by the auxiliary image processing module 140 to control autofocus, auto white balance, automatic exposure, and/or short and long exposures for the auxiliary camera 120, as illustrated by representative feedback connection 307. The auxiliary image processing module 140 can also provide control information 313 as an output to be used for further processing.

Referring to the embodiment illustrated in FIG. 2B, the main camera 110 may include a lens 112, a controllable aperture 114, a sensor 116 and a controller 118. In some embodiments, the controller 118 may operably control movement of the lens 112 (or at least one lens element) for focusing, control the size of the aperture 114 and/or how long the aperture 114 is open to control exposure (and/or the exposure period), and/or control sensor 116 properties (for example, gain). Similarly the auxiliary camera 120 may include a lens 122, a controllable aperture 124, an imaging sensor 126, and a controller 128. In some embodiments, the controller 128 may operably control movement of the lens 122 (or at least one lens element) for focusing, control the size of the aperture 124 and/or how long the aperture 124 is open to control exposure (and/or the exposure period), and/or control sensor 126 properties (for example, gain).

Images may be captured at a spatial resolution and a frame rate by the main and auxiliary sensors 116, 126. The main and auxiliary sensors 116,126 may comprise rows and columns of picture elements (pixels) that may use semiconductor technology, such as charged couple device (CCD) or complementary metal oxide semiconductors (CMOS) technology, that determine an intensity of incident light at each pixel during an exposure period for each image frame. In some embodiments, the main and auxiliary sensors 116, 125 may be the same or similar sensors. In some embodiments, the auxiliary sensor 126 may be a lower quality or have lower imaging capabilities such that it is less expensive. For example, in some embodiments the auxiliary sensor 126 may produce data representative of a black and white image. In some embodiments, incident light may be filtered to one or more spectral ranges to take color images. For example, a Bayer filter mosaic on the auxiliary sensor 126 may filter light using red, green and blue filters capture full color, three band images.

As illustrated in the embodiment of FIG. 2B, the apparatus 100 may include a touch screen 150 that accepts user input and displays a user interface for command input, as well as captured or processed imagery. Command input may include a command to start or stop capturing imagery, and may indicate whether the imagery to capture is a still image, a video, and whether to capture the imagery at high dynamic range with a combination of exposures. The user may the touch screen or other input device to start and stop imagery capture, selects still image capture or video, select still image format (e.g., standard, square, and panorama), specify spatial resolution, size, and frame rate, and whether to capture imagery in standard or high dynamic range.

In the embodiment illustrated in FIG. 2B, the imaging system 200 may also include a camera controller 210 in communication with working memory 260. The camera controller 210, as further described below, is also in data communication with the main image processing module 130 and the auxiliary image processing module 140. As illustrated in the embodiment of FIG. 2A, the camera controller 210 can receive control information 213 from the auxiliary image processing module 140 and determine AF, AWB and AEC control information for the main camera 110 based at least in part on the control information 213 from the auxiliary image processing module. The camera controller 210 can also send, via control connection 223, the determined control information 227 to the main camera 110 to control AF and AEC operations and/or send control information 229 to the main image processing module 130 to control AWB operations. The camera controller 210 can use control information 213 from the auxiliary image processing module 140 and determine AF, AWB and AEC control information for the auxiliary camera 120 based at least in part on the control information 213 from the auxiliary image processing module. The camera controller 210 can also send, via control connection 233, the determined control information 237 to the auxiliary camera 120 to control AF and AEC operations and/or send control information 239 to the auxiliary image processing module 140 to control AWB operations. In the embodiment illustrated in FIG. 2B, the apparatus 100 may include also memory 250 to store imagery, control parameters, camera models, and/or software instructions.

In the embodiment illustrated in FIG. 2C, the imaging system 200 may also include a camera controller 210 in communication with working memory 260. The camera controller 210, as further described below, is also in data communication with the main image processing module 130 and the auxiliary image processing module 140. As illustrated in the embodiment of FIG. 2A, the camera controller 210 can receive control information 313 from the auxiliary image processing module 140 and determine AF, AWB and AEC control information, as well as short and long exposure periods to capture high dynamic range images, for the main camera 110 based at least in part on the control information 305 from the auxiliary image processing module. The camera controller 210 can also send, via control connection 323, the determined control information 327 to the main camera 110 to control AF and AEC operations, as well as short and long exposure periods for high dynamic range image capture, and/or send control information 329 to the main image processing module 130 to control AWB operations. The camera controller 210 can also send, via control connection 333, the determined control information 337 to the auxiliary camera 210 to control AF and AEC operations, as well as short and long exposure periods for high dynamic range image capture, and/or send control information 339 to the auxiliary image processing module 140 to control AWB operations. In the embodiment illustrated in FIG. 2B, the apparatus 100 may include also memory 250 to store imagery, control parameters, camera models, and/or software instructions.

Automatic Focus

In some embodiments of focusing operations, the auxiliary image processing module 130 receives captured raw imagery 201 from the auxiliary camera 227 and determines to control information for automatic focus, automatic white balance, and automatic exposure control. By adjusting the focal plane relationship between an element of auxiliary lens 122 and the auxiliary image sensor 126, objects may be focused on the auxiliary image sensor 126. As a scene is focused, high frequency content of the captured image increases because objects in focus have sharp edges. Accordingly, focus may be automated by varying the focal plane relationship between an element of auxiliary lens 122 and the auxiliary image sensor 126, calculating the relative amount of high frequency content, and setting the focal plane relationship to correspond to the position that maximizes high frequency content. For some implementations, the high frequency content for a portion of the scene selected by the user is used to focus the image, as objects at different distances from the lens will come into and out of focus. Once a focus setting is determined, a processor may estimate the distance of in-focus objects based on the selected focus distance. This distance may applied by the camera controller 210 to a camera model of a main camera 110 to estimate a focal plane relationship between an element of main lens 112 and the main image sensor 116 using image statistics for images captured by the auxiliary camera 110.

Automatic White Balance

Outside ambient lighting conditions may vary with time of day and cloud cover. Indoor ambient lighting conditions can vary greatly based on the amount of light present and the type of light source, for example, incandescent, fluorescent, halogen, LED or candle light. In some circumstances ambient lighting may include both sunlight and indoor lights. Different ambient lighting conditions lead to differences in illumination. For example, an object that appears white at noon on a sunny day may appear off-white under an incandescent bulb, slightly yellow in candlelight, or appear bluer when illuminated by an LED.

Different lighting conditions can be characterized by differences in relative spectral power distributions. The Commission Internationale de l'Eclairage (CIE) standards body maintains illumination models that provide different spectral weights for different spectral regions in the visible range. For example, CIE illuminant models A, C, D50, D65, F2, F7, and F11 model incandescent, daylight, daylight with a color temperature of 5000 degrees Kelvin, daylight at 6500 degrees Kelvin, broad band daylight, and narrow band daylight. Different spectral ranges can be equalized to correct for variations in ambient lighting conditions. In an implementation, the red and blue balance may be adjusted to reduce differences in color as ambient lighting conditions change.

Automatic white balance correction factors are calculated by the auxiliary image processing module 140 by estimating the relative spectral power distribution for images captured by the auxiliary camera 120, determining the averaging intensity in each spectral band, applying a model (for example, assuming that the average scene color follows an expected distribution), and then determining spectral weighting factors to equalize or adjusting spectral component so that the different spectral bands approximate the assumed distribution. These spectral weighting factors may applied by the camera controller 210 to a camera model of the spectral characteristics of the main camera 110 to map the spectral weightings of the auxiliary camera 120 for automatic white balance to the spectral weightings of the main camera 110 for automatic white balance. For some implementations, white balancing may also be used to correct known image sensor sensitivity variations in different spectral regions.

Automatic Exposure Control

The exposure may be described as the amount of light per unit area incident on an image sensor. Exposure is dependent on the scene luminance, auxiliary lens aperture 122, and shutter speed. Automatic exposure control may adjust the shutter speed or time for each exposure to an optimum exposure period, which corresponds to the amount of time the auxiliary image sensor 126 receives incident light to determine intensity at each pixel for an image frame. If the exposure period is too short, the image may be underexposed and detail in dark regions will not be visible. If the exposure period is too long, the image may be saturated and detail in light regions will not be visible. For scenes with relatively uniform lighting, the optimum exposure period is relatively constant throughout the scene.

An “optimal” exposure period may be estimated using a light meter (not shown), and/or capturing one or more images by auxiliary image sensor 126, calculating image statistics of the captured image(s) by the auxiliary image processing module 140, and setting the exposure period based on the image statistics and/or light meter reading. An intensity histogram may be used to determine, by auxiliary image processing module 140, whether an the image is either underexposed or saturated, as underexposed pixels will have intensity values close to zero, and saturated pixels will have intensity values close to the maximum (for example, 255 for eight bit intensity values). Intensity histogram statistics may be used to characterize, by auxiliary image processing module 140, whether the image may be underexposed or saturated. The auxiliary image processing module 140 determines the parameters to adjust the auxiliary aperture, the shutter or exposure period the auxiliary aperture exposure period until the image or histogram statistics are within desired limits, to reach an “optimal” exposure. The auxiliary image processing module 140 outputs automatic exposure control information and parameters to the auxiliary camera 120 for image capture by the auxiliary camera, and to the camera controller 210. The camera controller 210 maps the aperture and shutter speed exposure period for the auxiliary camera 120 to an aperture and shutter speed exposure period for the main camera 110 based on camera models of the main camera and auxiliary camera.

As noted above, the auxiliary image processing module 140 provides control information for autofocus, automatic white balance, and automatic exposure control 213 to the camera controller 210. The camera controller 210 uses this information, as described above, to determine autofocus, automatic white balance, and automatic exposure control 223 parameters information 223 for the main camera and main image processing module.

The main camera 110 receives focus and exposure control information 227 from the camera controller 210. The main controller 118 controls the focus of the main lens 112 by adjusting a focal plane relationship between an element of the main lens 112 and the main sensor 116. The main controller may also control a main aperture 114 opening and an exposure period of incident light through the main lens 112 onto the main sensor 116 to capture images during an exposure period.

Images may be captured at a spatial resolution and a frame rate by the main sensor 116 based on user input received via a touchscreen 150 another input device (not shown), or under program control. The spatial resolution for images captured by the main sensor 116 may be higher than the spatial resolution of images captured by the auxiliary sensor 126. The frame rate of imagery captured by the main sensor 116 may be higher than the frame rate of the images captured by the auxiliary sensor 126. The main sensor may comprise rows and columns of picture elements (pixels) that may use semiconductor technology, such as charged couple device (CCD) or complementary metal oxide semiconductors (CMOS) technology, that determine an intensity of incident light at each pixel during an exposure period for each image frame. The main sensor 116 may take a black and white image, or incident light may be filtered to one or more spectral ranges to take color images. For example, a Bayer filter mosaic on the main sensor 116 may filter light using red, green and blue filters capture full color, three band images. The main image sensor 116 may capture an image in visible or non-visible spectral ranges. Multispectral cameras capture multiple spectral bands of data (for example, 4-20 bands of data). Hyperspectral cameras capture a multiplicity of bands of data, often as a spectral response at each picture element to capture an image cube. Exemplary embodiments herein may use three band cameras with Bayer filters for clarity of discussion, but the disclosed technology is not limited to these three band cameras.

The main image processing module 130 receives captured raw imagery 201 from the auxiliary camera 227 and white balance control information from the camera controller 210. The white balance control information may contain weight factors for different spectral bands. The main image processing module may apply the weighting factors to the different spectral bands to equalize or white balance the imagery, thereby producing balanced processed imagery that is output by the main image processing module 130 for viewing, storage in memory 250, or further processing. The main image processing module may compute image statistics from the raw input imagery to determine control information for auto focus, automatic white balance, or automatic exposure control.

The main image processing module 130, the auxiliary image processing module 140, and the camera controller 210 are three separate modules in the exemplary embodiment depicted in FIG. 2A. For other embodiments, these modules may be combined in various combinations. For some implementations, the main image processing module 130 and camera control 210 may be a single module. For some implementations, the main image processing module 130 and auxiliary image processing module 140 may be a single module. For some implementations, the main image processing module 130, auxiliary image processing module 140, and camera controller 210 may be a single module. Each of the aforementioned modules and controller may be implemented in hardware, software, or firmware, or in some combination thereof. For some implementations, at least one of the main and auxiliary image processing modules is an image processing module.

The imagery captured by main sensor 116 or auxiliary sensor 118 may be still images or video. The imagery resolution of still images and video, and frame rate of video may vary based on user selection. Frames may be combined in different ways, for example by stitching them together to form a panorama. The image sensor 135, 145 may take a black and white image, or incident light may be filtered to one or more spectral ranges to take color images.

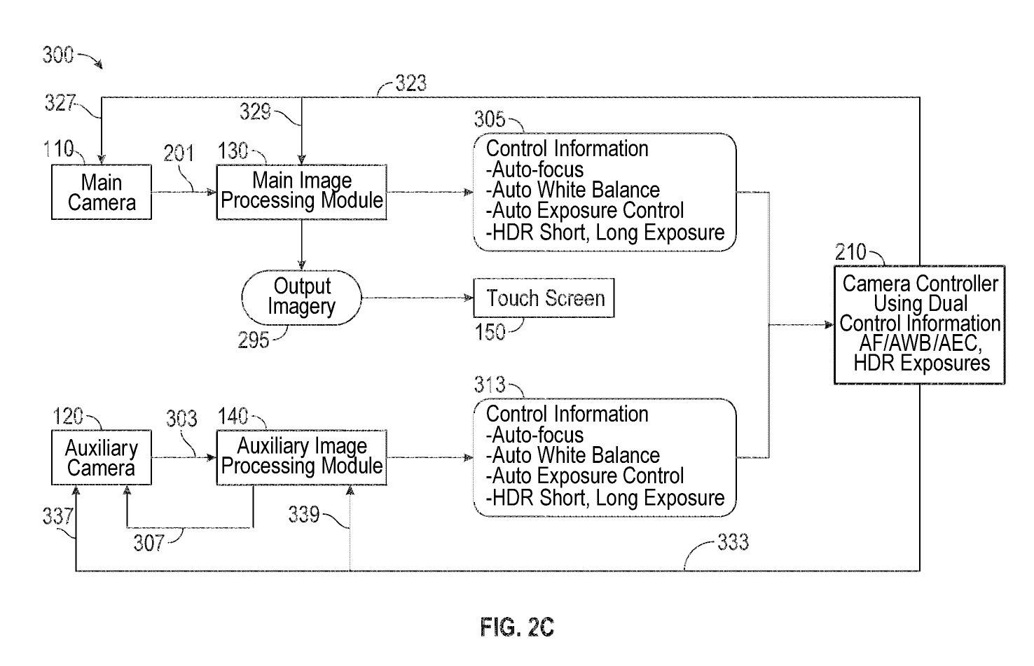

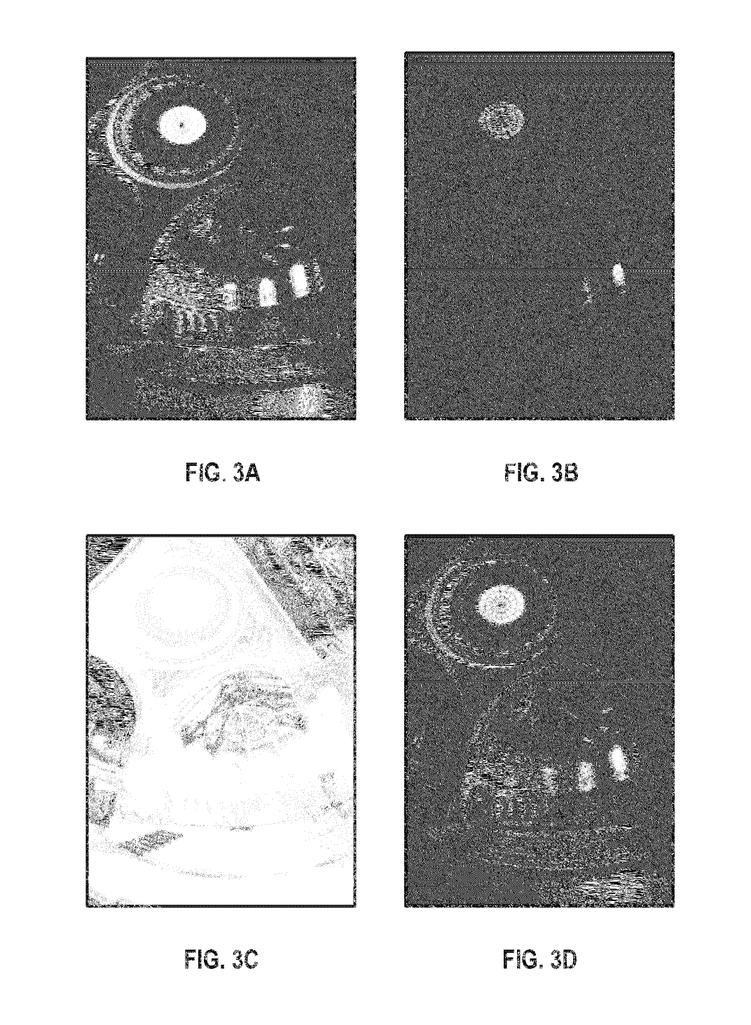

Scenes with highly variable lighting may include both bright well lit objects and dark shadowed objects. FIGS. 3A, 3B, 3C and 3D illustrate representations of images. In particular, FIG. 3A is a representation of an image that illustrates an example of a high dynamic ranges scene captured at an “optimal” exposure. FIG. 3B is a representation of an image that illustrates an example of the same scene illustrated in FIG. 3A where the image was made using about half the exposure period as was used to capture the image in FIG. 3A. FIG. 3D is a representation of an image that illustrates an example of a high dynamic range image generated by combining the images illustrated in FIGS. 3A, 3B and 3C.

FIG. 3A shows a high dynamic range scene captured with a certain exposure that may have been determined to be an “optimal” exposure as determined by the camera or imaging device that sensed light from the scene and generated the image. It is difficult to see detail in the bright skylight and stained glass windows as these regions may be saturated. It is also difficult to see detail in dark regions, such as the left arched ceiling area. The bright well lit objects require shorter exposure periods to avoid saturation, and the dark shadowed objects require longer exposure periods so that detail is visible. In order to capture high dynamic range imagery, images of different exposure periods may be combined. For example, short exposure, medium exposure, and long exposure images may be taken of a scene and then combined to avoid underexposure or overexposure of dark and bright objects, respectively. The FIG. 3B exposure is half the exposure used to capture the image illustrated in FIG. 3A. It is possible to see more detail in the skylight and the bright stain glass windows than is possible in FIG. 3A. The image illustrated in FIG. 3C (same scene as in FIG. 3A) was generated with twice the exposure as was used to generate the image illustrated in FIG. 3A. In this case, detail in the dark archway and carpeted stairs are visible, but much of the rest of the image is saturated. FIG. 3D combines the images taken at the different exposures (illustrated in FIGS. 3A, 3B, and 3C) to create a high dynamic range resulting image for which it is possible to view detail in both bright and dark regions.

This process may be automated, with variable settings for the number of combined images and the relative exposure periods. In some embodiments, for example, once the “optimal” exposure period is measured for the overall scene, images may be captured at half optimal exposure period, at the exposure period, and at twice the exposure period. Detail in bright regions of the image will be apparent in the short exposure image. Detail in dark regions of the image will be apparent in the long exposure image. By combining the three images, it may be possible to capture detail in dark, normal, and light regions of a scene. This example of combining three images, the images at half optimal, optimal, and twice optimal exposures, is just one example. Other exposure combinations may use four or more exposures, for example nine or sixteen exposures, each exposure at a different exposure period to capture high dynamic range still images and high dynamic range videos.

Just as the auxiliary image processing module 140 may determine an “optimal” automatic exposure by capturing one or more images by auxiliary sensor 126, calculating image statistics of the captured image(s) by auxiliary image processing module 140, and setting the exposure period based on the image statistics or light meter reading, auxiliary image processing module 140 may conduct a similar search to determine short and long exposures. The auxiliary image processing module 140 may select a short exposure period for which detail of bright objects is apparent. The auxiliary image processing module 140 applies a high dynamic range exposure metering algorithm by analyzing intensity histograms statistically to determine one or more short exposure periods. Similarly, the auxiliary image processing module 140 may select a long exposure period for which detail of dark objects is apparent, and a long exposure period for which detail of dark objects is apparent. The processor applies a high dynamic range exposure metering algorithm by analyzing intensity histograms statistically to determine one or more 1 exposure periods.

According to some embodiments, once powered on a camera system with a main (main) camera 110 waits for a computer or user input command to capture imagery. The imagery may be a still photo, a video, a high definition still photo, or a high definition video. Once a capture imagery command is invoked, the camera system captures images, collects image statistics, and then focuses the object image on an image sensor in an autofocus (AF) operation. The camera system can automatically determines spectral weightings for white balance (AWB), and automatically determines an exposure period (AEC), or set of exposure periods for high dynamic range imagery. It takes a finite amount of time for autofocus, automatic white balance, and automatic exposure control after power is turned on, when lighting conditions change, or the camera is pointed to an object that is not in focus. This introduces a delay before it's possible to capture focused, balanced, well exposed imagery, including high dynamic range imagery. There is a need to reduce these convergence times.

By having an auxiliary camera 120 and auxiliary image processing module 140, it is possible to reduce or eliminate this convergence time delay. The auxiliary camera captures imagery at a lower resolution and/or a lower frame rate than the main camera. Therefore, the volume of data processed by the auxiliary image processing module 140 is less than the volume of data that is captured by the main image processing module 130 when calculating control information for automatic focus, automatic white balance, and automatic exposure control. With lower data rates, the computational load is reduced when to calculate image statistics and computes high frequency content, spectral weightings or histogram intensity values that are used for autofocus, automatic white balance, and automatic exposure control. With a reduced computational load, convergence time for autofocus, automatic white balance, and automatic exposure control is reduced when compared to making these same calculations using data captured by the higher resolution, higher frame rate main image processing module.

Furthermore, a dual camera system may turn on the auxiliary camera 120 and auxiliary image processing module 140 as soon as the dual camera is powered on. By not waiting for a capture imagery command, the dual camera system starts to converge to (determine) the autofocus, automatic white balance, and automatic exposure control parameters on power up. Therefore, the dual camera both starts earlier and takes less time to estimate the autofocus, automatic white balance, and automatic exposure control parameters. This reduces or eliminates the time between invoking imagery capture and being able to capture imagery that is focused, balanced, and correctly exposed.

The autofocus parameters computed based on images captured by the auxiliary camera 120 estimate the distance to the object, based on a camera model for the auxiliary camera 120. This distance is used with a camera model for the main camera 110 to determine the focal plane relationship between the main lens 112 and the main sensor 116. The spectral weightings derived for the auxiliary camera 120 are used to determine spectral weightings for the main camera 110—either directly, or with correction for spectral response characteristic differences between the auxiliary camera 120 and the main camera 110. The ambient lighting characteristics determined by the auxiliary camera 110 and auxiliary image processing module 140 are used to determine the shutter speed exposure period and aperture setting and for the main camera 110. For some implementations, image statistics from both the main image processing module 130 and the auxiliary image processing module 140 are combined for faster convergence.

After the main image processing module 130 or auxiliary image processing module 140, or camera controller 210 determines the “optimum” exposure period, the exposure may be locked until a change in the scene is detected because of variations in image statistic. Once the change is detected, the auxiliary camera 120 and auxiliary image processing module 140 may refine the exposure period in response to the scene change. After determining the new “optimum” exposure, the auxiliary camera 120 and auxiliary image processing module 140 may search for short and long exposure periods. The auxiliary image processing module 140 may then output this information to the camera controller 210 which generates equivalent exposure periods for the main camera 110 via exposure synchronization control between the main camera 110 and the auxiliary camera 120. When the user requests high dynamic range imagery via the touchscreen 150 or other input device (not shown) the main camera 110 and main image processing module 130 captures images at short, “optimum,” and long exposure periods. The main image processing module 130 then combines the imagery captured at short, “optimum,” and long exposure periods to form high dynamic range imagery. The high dynamic range imagery may be output to memory 250 and viewed on the touchscreen 150.

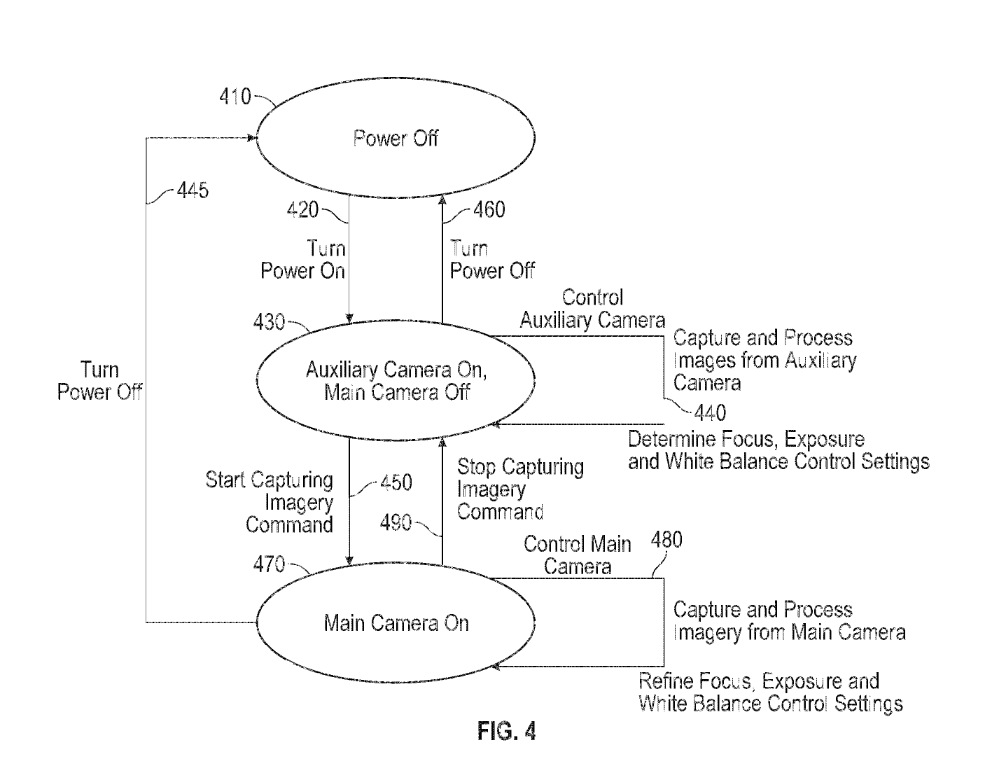

FIG. 4 is a state diagram illustrating an example of states and state transitions for some embodiments of an embodiment of an imaging system having two cameras, the state diagram showing states of a main camera and an auxiliary camera during autofocus, automatic white balance and automatic exposure control operations, and as the imaging system captures focused, balanced, and properly exposed imagery. FIG. 4 shows a state transition diagram 400 for a dual camera system, which operates in power off state 410 (power off), auxiliary capture state 430 (auxiliary camera on, main camera off), or main capture state 470 (main camera on). The dual camera system transitions from power off state 410 to auxiliary capture state 430 when power is turned on 420, and transitions back from auxiliary capture state 430 to power off state 410 when power is turned off. While in auxiliary capture state 430, the auxiliary controller 128 controls the auxiliary camera, the auxiliary camera 120 captures imagery, the auxiliary image processing module 140 process images from the auxiliary camera 120 and determines focus, exposure, and white balance control settings, during state transition 440.

The dual camera system transitions from auxiliary capture state 430 to main capture state 470 when a start imagery capture command is invoked by a user or software 450, and transitions back from main capture state 470 to auxiliary capture state 430 when a stop imagery capture command is invoked by a user or software 490. While in main capture state 470, the camera controller 210 controls the main camera, the main controller 118 controls the main camera 110, the main camera 110 captures imagery, the main image processing module 130 processes the captured imagery, and the main image processing module 130 refines the automatic focus, automatic white balance, and automatic exposure control parameters, during state transition 480.

For some implementations, the auxiliary camera 120 will keep capturing imagery while in the main video capture state 470, and the image statistics from these images may be used, in addition to image statistics from the main image processing module, to refine the automatic focus, automatic white balance, and automatic exposure control parameters during state transition 480. If power is turned off 495 while in main capture state 470, the dual camera system transitions to power off state 410.

A user may preview images on the touchscreen 150 during operation, and issue commands via the touchscreen 150. For example, while in main capture state 470, the user may view a changing scene. The main image sensor continues to capture images.

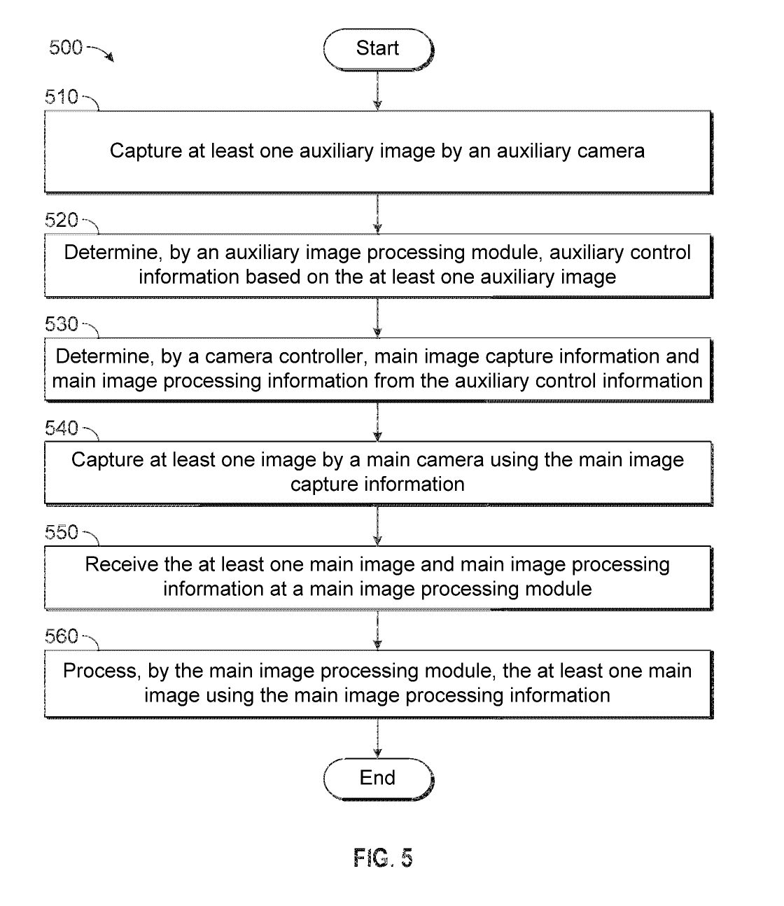

FIG. 5 is a flowchart that illustrates an example of a process 500 for rapid automatic exposure control, automatic white balance, and automatic focus convergence. At block 510, the process 500 captures at least one auxiliary image. In some implementations, the functionality of block 510 may be performed by the auxiliary camera 120 illustrated in FIG. 2B. At block 520, the process 500 determines auxiliary control information based on the at least one auxiliary image. In some implementations, the functionality of block 520 may be performed by the auxiliary image processing module 140 illustrated in FIG. 2B.

At block 530, the process 500 determines main image capture information and main image processing information from the auxiliary control information. In some implementations, the functionality of block 530 may be performed by the camera controller 210 illustrated in FIG. 2B. At block 540, the process 500 captures at least one main image using the main image capture information. In some implementations, the functionality of block 540 may be performed by the main camera 110 illustrated in FIG. 2B. At block 550, the process 500 receives the at least one main image and main image processing information. In some implementations, the functionality of block 550 may be performed by main image processing module 130 illustrated in FIG. 2B.

At block 560, the process 500 processes the at least one main image using the main image processing information. In some implementations, the functionality of block 560 may be performed by the main image processing module 130 illustrated in FIG. 2B.

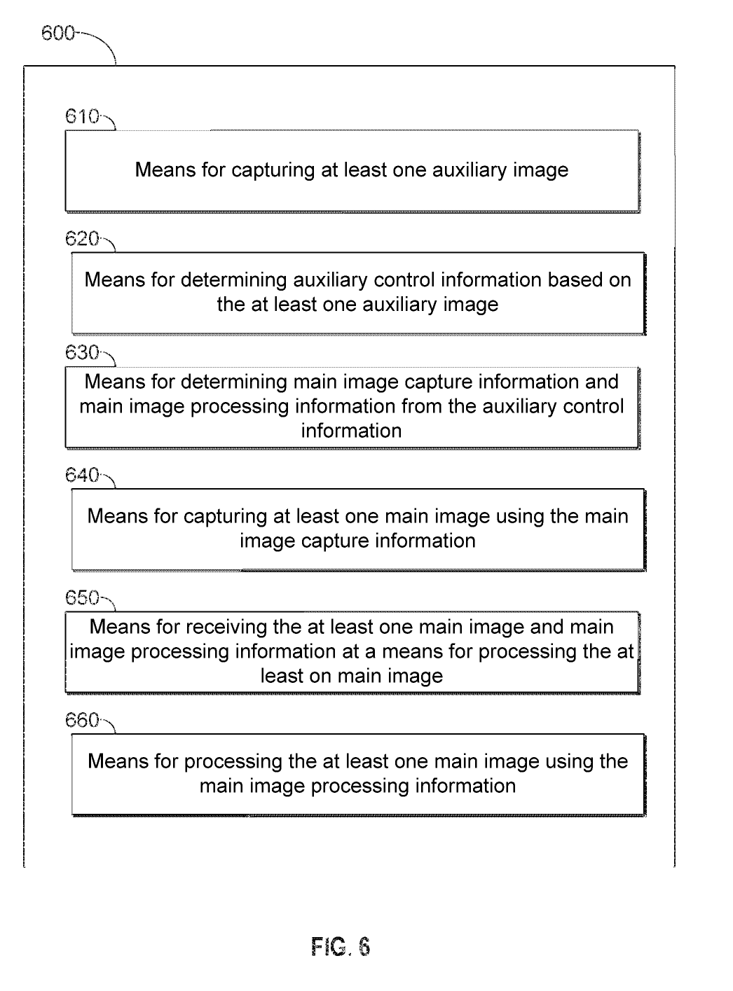

FIG. 6 is a block diagram illustrating an example of an imaging system having two cameras (for example, each camera having a lens and a sensor) configured for automatic exposure control, automatic white balance, automatic focus, and high dynamic range exposure metering. The apparatus may include means 610 for capturing at least one auxiliary image. In some implementations, the auxiliary image capturing means may be an auxiliary camera 120. The apparatus may include means 620 for determining auxiliary control information based on the at least one auxiliary image. In some implementations, the determining auxiliary control information means may be an auxiliary image processing module 140.

The apparatus may include means 630 to determine main image capture information and main image processing information from the auxiliary control information. In some implementations, the determining main image capture and main image processing information means may be a camera controller 210. The apparatus may include means 640, to capture at least one main image using the main image capture information. In some implementations, the capturing main image means may be a main camera 110. The apparatus may include means 650 to receive the at least one main image and main image processing information. In some implementations, the receiving main image and main image processing information means may be a main image processing module 130.

The apparatus may include means 660 to process the at least one main image using the main image processing information. In some implementations, the processing main image means may be a main image processing module 130.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of: A, B, or C” used in the description or the claims means “A or B or C or any combination of these elements.”

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus comprising:
a main camera configured to receive main image capture information and capture an image using the image capture information;
a main image processing module in communication with the main camera, the main image processing module configured to receive an image from the main camera, receive main image processing information, and process the image received from the main camera using the main image processing information;
an auxiliary camera configured to capture an image;
an auxiliary image processing module in communication with the auxiliary camera, the auxiliary image processing module configured to receive at least one image from the auxiliary camera and determine auxiliary control information based on the at least one image received from the auxiliary camera; and
a camera controller in communication with the auxiliary image processing module, the camera controller configured to
receive the auxiliary control information from the auxiliary image processing module,
determine main image capture information and main image processing information from the auxiliary control information,
communicate the main image capture information to the main camera, and
communicate main image processing information to the main image processing module.

2. The apparatus of claim 1, wherein the main image capture information includes information for operating the main camera to perform autofocus operations and for controlling exposure.

3. The apparatus of claim 2, wherein the main camera is configured to use the additional main image capture information to perform autofocus operations and to control exposure.

4. The apparatus of claim 1, wherein the main image processing information comprises information for performing a white balance adjustment of an image received from the main camera.

5. The apparatus of claim 1, wherein the auxiliary control information comprises information for controlling the auxiliary camera and processing the auxiliary image.

6. The apparatus of claim 4, wherein auxiliary control information further comprises exposure information.

7. The apparatus of claim 2,
wherein the main image processing module is further configured to determine main control information, and
wherein the camera controller is configured to receive main control information from the main image processing module, determine additional main image capture information for autofocus and exposure control based at least in part on the auxiliary control information and the main control information, and communicate the additional main image capture information to the main camera.

8. The apparatus of claim 7, wherein the main camera is configured to use the additional main image capture information to perform autofocus operations and control exposure based on the additional main image capture information.

9. The apparatus of claim 2,
wherein the auxiliary control information includes autofocus data, wherein the auxiliary camera comprises an auxiliary lens, and
wherein the auxiliary image processing module and the auxiliary camera are collectively configured to determine the autofocus data by moving the auxiliary lens to a plurality of positions, capturing an image at each of the positions, and determining at which position an image includes the most high frequency information.

10. The apparatus of claim 6, wherein auxiliary control information comprises white balance information, and wherein the auxiliary image processing module is configured to determine the white balance information of an image captured by the auxiliary camera.

11. The apparatus of claim 1, wherein the camera controller is configured to switch to an auxiliary capture mode in response to powering on the apparatus or when the apparatus operates switches from a recording mode to a non-recording mode, the camera controller determining the main image capture information and the main image processing information while in the auxiliary image capture mode based on the at least one image received from the auxiliary camera.

12. A method, comprising:
capturing at least one auxiliary image by an auxiliary camera;
determining, by an auxiliary image processing module, auxiliary control information based on the at least one auxiliary image;
determining, by a camera controller, main image capture information and main image processing information from the auxiliary control information;
capturing at least one main image by a main camera using the main image capture information;
receiving the at least one main image and main image processing information at a main image processing module; and
processing, by the main image processing module, the at least one main image using the main image processing information.

13. The method of claim 12, wherein the auxiliary control information comprises autofocus information, exposure information and white balance information for controlling the auxiliary camera and processing the at least one auxiliary image.

14. The method of claim 13, wherein the main image capture information comprises autofocus information and exposure information for use by the main camera.

15. The method of claim 13, wherein the main image processing information comprises white balancing information, and wherein processing the at least one main image using the main image processing information comprises changing a color of the at least one image color based on the white balancing information.

16. The method of claim 12, further comprising:
switching to an auxiliary capture mode when the apparatus is powered on; and
switching to an auxiliary capture mode when the apparatus switches from a recording mode to a non-recording mode,
wherein the at least one auxiliary image is captured when the apparatus is in the auxiliary capture mode.

17. The method of claim 12, further comprising:
determining additional main control information based on the at least one main image; and
communicating the additional main control information to the camera controller; and
determining additional main image capture information by the camera controller, the additional main image capture information based at least in part on the auxiliary control information and the additional main control information.

18. The method of claim 17, further comprising:
communicating the additional main image capture information to the main camera; and
using the additional main image capture information by the main camera to perform autofocus and control exposure while capturing at least one additional main image.

19. The method of claim 17, wherein the additional main control information is determined by the main image processing module.

20. An apparatus comprising:
means for capturing at least one auxiliary image;
means for determining auxiliary control information based on the at least one auxiliary image;
means for determining main image capture information and main image processing information from the auxiliary control information;
means for capturing at least one main image using the main image capture information;
means for receiving the at least one main image and main image processing information at a means for processing the at least one main image; and
means for processing the at least one main image using the main image processing information.

21. The apparatus of claim 20, wherein the auxiliary control information comprises autofocus information, exposure information and white balance information for controlling the means for capturing at least one auxiliary image and processing the at least one auxiliary image.

22. The apparatus of claim 21, wherein the main image capture information comprises autofocus information and exposure information for use by the means for capturing at least one main image.

23. The apparatus of claim 21, wherein the main image processing information comprises white balancing information for use by the means for capturing at least one main image.

24. The apparatus of claim 20, further comprising:
means for switching to an auxiliary capture mode when the apparatus is powered on; and
means for switching to an auxiliary capture mode when the apparatus switches from a recording mode to a non-recording mode,
wherein the at least one auxiliary image is captured when the apparatus is in the auxiliary capture mode.

25. The apparatus of claim 20, further comprising:
means for determining additional main control information based on the at least one main image; and
means for determining additional main image capture information by the camera controller, the additional main image capture information based at least in part on the auxiliary control information and the additional main control information.

26. The apparatus of claim 25, further comprising:
means for communicating the additional main image capture information to the means for capturing at least one main image,
wherein the means for capturing at least one main image is configured to use the additional main image capture information by to perform autofocus and control exposure while capturing at least one additional main image.

27. A computer program product comprising a non-transitory computer readable medium encoded thereon with instructions that when executed cause an apparatus to perform a method of capturing an image, the method comprising:
capturing at least one auxiliary image by an auxiliary camera;
determining auxiliary control information based on the at least one auxiliary image;
determining main image capture information and main image processing information from the auxiliary control information;
capturing at least one main image by a main camera using the main image capture information;
receiving the at least one main image and main image processing information at a main image processing module; and
processing the at least one main image using the main image processing information.

28. The computer program product of claim 27, wherein the auxiliary control information comprises autofocus information, exposure information and white balance information for controlling the auxiliary camera and processing the at least one auxiliary image.

29. The computer program product of claim 27, wherein the main image capture information comprises autofocus information and exposure information for use by the main camera.

30. The computer program product of claim 27, wherein the main image processing information comprises white balancing information for use by the main image processing module.
